(19) United States
(12) Patent Application Publication
(10) Pub. No.: US 2007/0158509 A1
(43) Pub. Date: Jul. 12, 2007

(54) Pool cue case of musicians instrument case with tripod stand and rest

(76) Inventor: Shannon Richard Hubbell, Valley Springs, CA (US)

Correspondence Address: Galasso & Associates, LP, P.O. Box 26503, Austin, TX, 78755-0503, US

(21) Appl. No.: 11/588,728

(22) Filed: Oct. 27, 2006

Related U.S. Application Data
(60) Provisional application No. 60/756,909, filed on Jan. 6, 2006.

(51) Int. Cl. F16M 11/38; A47F 5/12; F16M 13/00

(52) U.S. Cl. 248/171; 248/528; 211/172

(57) ABSTRACT

In one set of embodiments a pool cue case is equipped with a tripod type stand adapting the pool cue case to stand in an angled upright position on its own without the need to lean against a wall or table and provide improved visibility so as not be trampled by pool players and guests. The pool cue case includes a pool cue rest where the pool cue can be placed between turns. The pool cue rest shelters the pool cue against the case while the cue is not in play while also placing the pool cue at a convenient elevation so as to be readily retrieved by a standing pool player. In another set of embodiments a musical instrument case is equipped with a tripod stand and an instrument rest for instruments such as the flute, violin, varieties of horns, as well as other instruments in a manner similar to the pool cue case discussed above.

### CROSS REFERENCE TO RELATED APPLICATIONS

This application claims priority to co-pending U.S. Provisional Patent Application having Ser. No. 60/756,909 filed Jan. 6, 2006 entitled “Cue Caddy”, having a common applicant herewith.

### FIELD OF THE DISCLOSURE

The disclosures made herein relate generally to cases or carriers for protectively enclosing and transporting pool cue sticks from one place to another and, in particular, to pool cue cases equipped with a tripod stand for supporting the case in an upright or angled upright position upon a floor surface. The pool case further includes a pool cue rest. The disclosures herein are also directed to a case for musical instruments. The case having a tripod stand for supporting the case in an upright or angled upright position upon a floor together with an instrument rest upon which the instrument may be placed when not in use.

### BACKGROUND

Pool or billiards is a popular game played on a six pocket table having a plurality of colored and numbered hard balls including a generally white cue ball. Pool or billiards involves hitting the cue ball with the tip of a pool cue stick to urge the cue ball to impact another hard ball with goal of transferring momentum from the cue ball to the impacted ball in a way that causes the impacted ball to roll in a directed fashion towards and fall into one of the pockets of the table.

Pool, as with other competitive games, has its own following of enthusiasts and pool players gain considerable skill at the game over time. Pool is played in tournaments and in leagues, as well as just for competitive fun in taverns, bowling alleys, pool halls and various other establishments. More serious players tend to bring their own pool cues. Pool cues are like golf clubs in that a player who is accustomed to the use of a particular pool cue may find their game is off when attempting to use another pool cue. Players competing in tournaments or otherwise playing the game seriously often carry their own high quality pool cues and equipment. In pool while a pool player is waiting their turn to play, the pool player will often lean or rest the pool cue against a table, wall, chair, stool or any other article that can serve as a rest. Often the pool cue will be bumped by other players and observers, or may just slide off the edge of the table or stool to fall onto the floor where the pool cue may be damaged. For serious pool players who have invested considerable sums on money into the purchase of proper competitive pool cues, the resultant damage is costly and aggravating.

Various cases for the transport and protection of pool cue are known. Such cases are available in hard cases, tubular cases and soft cases of various kinds. Such cases are useful for protecting the pool cue during transport to a tournament or to an establishment for play. While known pool cases are useful, they have one or more drawbacks. While conventional pool cue cases protect the pool cue during transport, they to do not offer protection to the pool cue once the pool game has started, that is to say they do not offer a sheltered pool cue rest on which to place the pool cue between turns. Conventional pool cue cases and carriers have another drawback in that there is no convenient place to safely place pool cue case or carrier while the pool game is in progress. As known cases lack a means of standing upright on their own, they must be placed out of the way where they will not be trampled on or have food and beverages spilled upon them by other guests and players. During pool game play conventional pool cue stick cases are a liability and problem rather than an asset to the pool player.

Therefore the need exists for a pool cue case that is equipped to stand upright on its own without the need to lean against a wall or table, a pool cue case that is equipped to stand upright in a highly visible fashion so it is not trampled by other players and guests, a pool cue case that provides a pool cue rest where the pool cue can be placed between turns, a pool cue rest which shelters the pool cue against the case. There is also the need for a kit to retrofit existing pool cue cases and carriers to have the features discussed above, namely, the ability to have the pool cue case stand upright on its own and provide a sheltered pool cue rest for placement of the pool cue when not in play. There is a related need for a case as disclosed herein for a musical instrument case that is equipped to stand upright and provide an instrument rest for instruments such as the flute, violin, varieties of horns, as well as other instruments.

### SUMMARY OF THE DISCLOSURE

Accordingly, embodiments of the inventive disclosures made herein comprise various embodiments of a pool cue or musical instrument case equipped with foldable tripod legs for supporting the cases in an angled upright position as well as a rest for supporting a pool cue or musical instrument when not in use. By angled upright we mean the case is positioned to be near or at perpendicular relative to the floor. By angled upright we mean the case may be tilted from perpendicular by 30 degrees or less.

In a first embodiment a pool cue case comprises an elongated hard box pool cue case having a case base member and a case lid member hingeably attached to the base member. The case has a recess within for protectively receiving and storing a pool cue. The pool cue case includes a tripod stand for supporting the case in an inclined upright position, the tripod stand having one end foldably secured to the base member of the case by a hinge member. The tripod stand has an opposing second end adapted to support the case in an inclined upright position upon a floor surface by resting upon the tripod stand and one sidewall of the case. The second end of the tripod stand has at least two distally spaced points of contact with the floor, the second end having slip resistant feet secured thereto. The tripod stand is foldable against a back wall of the case base member when not being used, such as when transporting or carrying the case from place to place. The tripod stand folds outwards from the case to support the case in the upright position, say for example when placed near the pool table during a pool game. The case includes a means of holding the tripod stand in a folded position against the base member of the case when the tripod stand is not in use. During pool game play, it is advantageous to have a rest for the pool cue. The case further comprises a pool cue rest having a means of supporting a pool cue in an inclined upright alignment proximate to a front wall of the case wherein the butt end of the pool cue is supported by the front wall of the case. The case includes one or more clasps for holding the case base member and lid members in a closed position for protecting the pool cue within during transport from place to place.

Advantageously, the pool cue is supported in the pool cue rest in an inclined vertical position, supported above the floor by the pool cue case and pool cue support members. The pool cue is held in an inclined vertical position with the tip end if the cue extending upwards from the floor, with the pool cue tip end at an elevation placing the pool cue within easy reach of the pool player without requiring the player having to stoop over to retrieve the pool cue. The pool cue is sheltered against and supported by the pool cue case which is standing upright at an elevation where it is easily seen. The pool cue case is maintained in an inclined vertical position by the tripod floor stand attached to the pool cue case.

In a second embodiment the pool cue case of the first embodiment is modified to have the means of supporting the pool cue comprising a bottom cue support member hingeably secured to a front wall of the lid member of the case, the bottom cue support member foldable into the front wall flush with the front wall when not in use. Similarly the bottom cue support member is foldable outwards substantially perpendicular to the front wall for supporting the butt end of a pool cue upon the bottom cue support member. A top cue support member is hingeably secured to the front wall of the lid member of the case, with the top cue support member foldable into the front wall of the case such that it is flush with the front wall when the top cue support is not in use (for example when transporting the case). The top cue support member folds outwards to a position substantially perpendicular to the front wall of the case for supporting the tip end of a pool cue with the butt end the cue resting upon the bottom cue support member.

In a third embodiment the pool cue case of the first embodiment is modified to have the means of supporting the pool cue, also called the pool cue rest, comprises the following elements. First an elongated recessed channel formed into the front wall of the case for supportively resting or leaning the pool cue within the channel against the wall of the channel. The channel is aligned along the major length of the elongation axis of the case such that when the case is positioned in an inclined upright on its tripod legs, the channel is aligned in an inclined upright position. The channel wall is formed of a light transmitting material such as transparent or translucent plastic or glass, and is equipped with one or more light producing members to illuminate the channel as described below. A bottom support member is formed at the bottom end of the channel where the bottom support member closes the bottom of the channel and provides a support base for supporting butt end of the pool cue when it is placed in the pool cue rest. A pressure sensitive switch is secured to the bottom support member discussed above. The pressure sensitive switch has electrical contacts adapted to close whenever a pool cue is placed upon the bottom support member, the contacts reopening when the cue is removed. The switch is actuated by the weight of the pool cue on the bottom support member. The case further comprises one or more conventional dry cells or other replaceable batteries removably secured within the case. As discussed above, one or more lights are secured to the case and positioned behind the light transmitting plastic or glass material forming the recessed channel. The lights are preferably light emitting diodes (LED) due to their low power consumption and high efficiency although the invention is not limited to the use of LED lamps. The lights illuminate the recessed channel. The lights are electrically connected to and powered by the batteries and controlled by the pressure sensitive switch wherein placing a pool cue on the bottom support member energizes the lights and illuminates the elongated recessed channel. The lights illuminating the channel, besides providing a decorative and pleasing appearance, also improve the visibility of the cue case to other pool players and observers thereby reducing the chance of the pool case and pool cue being accidentally bumped or toppled by those passing nearby the case.

In a fourth embodiment the pool cue case of the third embodiment further comprises two elongated top support slide rods. The slide rods are positioned in spaced parallel relationship wherein the rods are telescopically received into or extendable outwards from the top portion of the cue case. The rods are substantially aligned with and telescoping parallel to the axis of elongation of the recessed channel. A top cue support member is provided. The top cue support member bridges between and is secured to the upper end of the two elongated top support slide rods. The top cue support member has a concave portion aligned with the axis of elongation of the recessed channel such that when a pool cue is placed into the recessed channel with its butt end resting upon the bottom support member, then the tip end of the pool cue rests within the concave portion of the top cue support member. The slide rods are retractable into the case when the top cue support member is not needed to support a pool cue, for instance when transporting the pool cue within the case from one place to another.

In a fifth embodiment a kit is provided having various components for adapting a pool cue case to have a tripod stand and the pool cue supports to provide a pool cue rest. The kit comprises a foldable bottom cue support member wherein the bottom cue support member is foldable outwards substantially perpendicular to the front wall of the pool cue case. A bottom cue support member is provided for supporting the butt end of a pool cue upon the bottom cue support member. The pool cue rest comprises a means of securing the bottom cue support member to the pool cue case. A top cue support member is provided. The top cue support member is foldable outwards substantially perpendicular to the front wall of the pool case wherein the top cue support member supports the tip end of a pool cue while the butt end of the pool cue rests upon the bottom cue support member. Also provided is a means of securing the bottom cue support member to the case such that the bottom cue support member is foldable outwards to a first position substantially perpendicular to the front wall of the case, as well as foldable to a second position against the front wall of the case, the first position being when the cue rest is in use, the second position for when the cue rest is not in use. The kit further includes a foldable tripod stand for supporting the case in an upright inclined position when resting on a floor. The kit includes a means of securing the tripod stand to the case such that the tripod stand is foldable outwards from the case to support the case in an inclined upright position.

In a sixth embodiment, the kit of the fifth embodiment is modified in the following ways. The pool cue case is a hard case. The means of securing the bottom cue support member to the case comprises a first ‘U’ shaped bracket having a flat back member and two opposing sides formed perpendicular to the back member. Each side of the bracket has a plurality of holes sized to receive screws therethrough for securing the bracket to the pool cue case. The bottom cue support member is foldably attached to the back member of the first ‘U’ shaped bracket. The means of securing the top cue support member to the case comprises a second ‘U’ shaped bracket having a flat back member and two opposing sides formed perpendicular to the back member of the second ‘U’ shaped bracket. The sides of the second bracket having a plurality of holes sized to receive screws for securing the second ‘U’ shaped bracket to the case, wherein the top cue support member is foldably attached to the back member of the second ‘U’ shaped bracket. The means of securing the tripod stand to the case comprises a third ‘U’ shaped bracket having a flat back member and two opposing sides formed perpendicular to the back member of the third ‘U’ shaped bracket. The sides of the third ‘U’ shaped bracket having a plurality of holes sized to receive screws for securing the bracket to the case, wherein the tripod stand is foldably attached to the back member of the third ‘U’ shaped bracket and thereby attached to the pool cue case to support the pool cue case in an inclined upright position.

In a seventh embodiment, the pool cue case is a tube case. The kit of the fifth embodiment is modified in the following ways. The kit further includes a frame member sized and adapted to extend along a portion of length of the tube case while resting along side the back side of the pool case. The kit further comprises two adjustable compression clamps. Each clamp has two opposing ‘C’ shaped clamp arms wherein the arms are sized and adapted to engage opposing sides of the tube case. Each clamp is secured to opposing ends of the flame member wherein the adjustable clamps adapt the frame member to be removably secured to the tube case. The means of securing the top cue support member to the case comprises a first sliding member having the top cue support member foldably secured to the first sliding member. The first sliding member is slidably received into the top adjustable compression clamp. The means of securing the bottom cue support member to the case comprises a second sliding member having the bottom cue support member foldably secured to the second sliding member. The second sliding member is slidably received into the bottom adjustable compression clamp. Also the means of securing the tripod stand to the case comprises the tripod stand foldably secured to a back surface of the flame member.

In an eighth embodiment a case for a musical instrument comprises an elongated instrument case having a case base member and a case lid member hingeably attached to the base member. The instrument case has a recess within the case for protectively receiving, storing and transporting a musical instrument. A tripod stand is provided for supporting the instrument case in a standing substantially upright or inclined upright position. The tripod stand has one end foldably secured to the base member of the case by a hinge member. The tripod stand has an opposing second end adapted to support the case in a substantially upright or inclined position upon a floor surface by resting upon the tripod stand and one sidewall of the case. The second end of the tripod stand has at least two distally spaced points of contact with the floor with the tripod second end additionally having slip resistant feet secured to the tripod where the tripod contacts the floor. The tripod stand is foldable against a back wall of the instrument case base member when not in use. The tripod stand is foldable outwards from the case to support the instrument case in the upright position. The instrument case further comprises a means of holding the tripod stand in a folded position against the base member of the instrument case when the tripod stand is not in use, for example while transporting the instrument cases from place to place. An instrument rest is provided comprising a means of supporting an instrument in a substantially vertical alignment proximate to a front wall of the case with the musical instrument supported by the front wall of the case. One or more clasps are provided for holding the case base member and lid members in a closed position.

In a ninth embodiment the musical instrument case of the eighth embodiment is an instrument case for a medium size instrument such as a violin, a flute, a horn or a guitar.

It is an objective of the inventive disclosure made herein to provide a pool cue case that is equipped to stand at an angled upright position without the need to lean against a wall or table.

It is another objective of the inventive disclosure made herein to provide a pool cue cases as it is equipped to be positioned to have improved visibility so as not to be trampled by other players and guests.

It is another objective of the inventive disclosure made herein to provide a pool cue cases that includes a pool cue rest where the pool cue can be placed while a pool player awaits their next turn.

It is another objective of the inventive disclosure made herein to provide a pool cue rest which shelters the pool cue against the case while the pool cue is in its rest.

It is another objective of the inventive disclosure made herein to provide a kit for retrofitting existing pool cue cases and carriers to provide the features discussed above, namely, the ability to have the pool cue case stand in an angles upright position and provide a sheltered pool cue rest for placement of the pool cue when not in play.

It is another objective of the inventive disclosure made herein to provide a musical instrument case that is equipped to stand in an angled upright position and provide an instrument rest for instruments such as the flute, violin, varieties of horns, as well as other instruments in a manner similar to the pool cue case discussed above.

These and other objects of the invention made herein will become readily apparent upon further review of the following specification and associated drawings.

### BRIEF DESCRIPTION OF THE DRAWINGS

The drawings show a form of the invention that is presently preferred; however, the invention is not limited to the precise arrangement shown in the drawings.

FIG. 1 depicts a perspective view of one embodiment of a hard box type pool cue case having the tripod stand and pool cue rest features in accordance with the inventive disclosures herein.

FIG. 2 depicts a rear view of the hard box type pool cue case of FIG. 1 depicting the folding tripod stand and retaining clips in accordance with the inventive disclosures herein.

FIG. 3 depicts a perspective view of another embodiment of a pool cue case having the tripod stand and pool cue rest features in accordance with the inventive disclosures herein.

FIG. 4A depicts a perspective view of one embodiment of a kit having various components installed onto and adapting a pool cue case to have a tripod stand and pool cue rest in accordance with the inventive disclosures herein.

FIG. 4B depicts a perspective view of another embodiment of a tripod stand for the kit depicted in FIG. 4A in accordance with the inventive disclosures herein.

FIG. 4C depicts an enlarged perspective view of the top cue support member of FIG. 4A.

FIG. 4D depicts an enlarged perspective view of the bottom cue support member of FIG. 4A.

FIG. 5 depicts a perspective view of another embodiment of a hard box type pool cue case having the tripod stand and pool cue rest features in accordance with the inventive disclosures herein.

FIGS. 6A and 6B depict a perspective view of another embodiment of a kit for adapting a tube case pool cue case to have the tripod stand and pool cue rest in accordance with the inventive disclosures herein.

### DETAILED DESCRIPTION OF THE DRAWINGS

In preparation for explaining the details of the present inventive disclosure, it is to be understood by the reader that the invention is not limited to the presented details of the construction, materials and embodiments as illustrated in the accompanying drawings, as the invention concepts are clearly capable of other embodiments and of being practiced and realized in various ways by applying the disclosure presented herein.

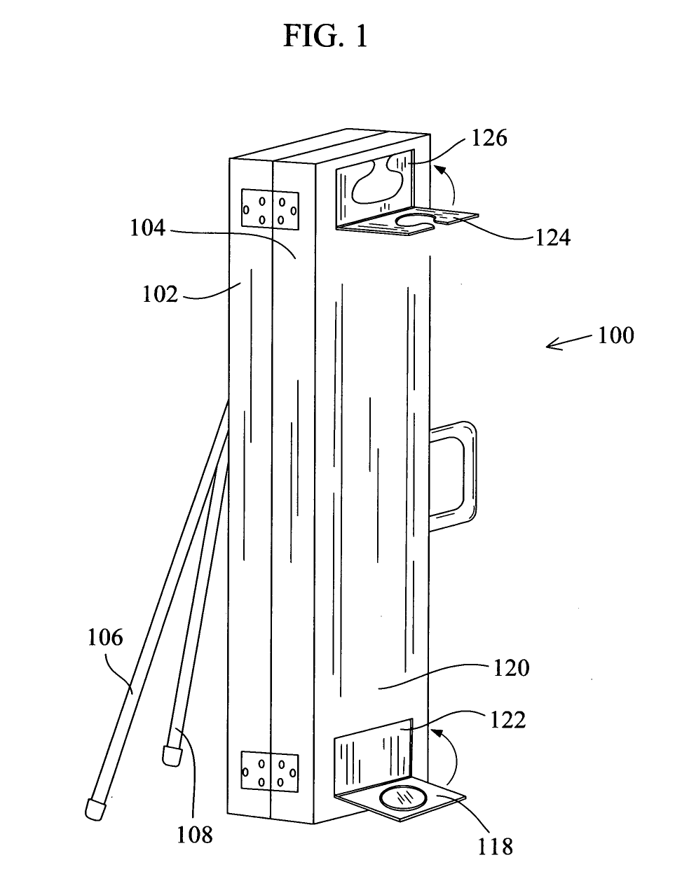

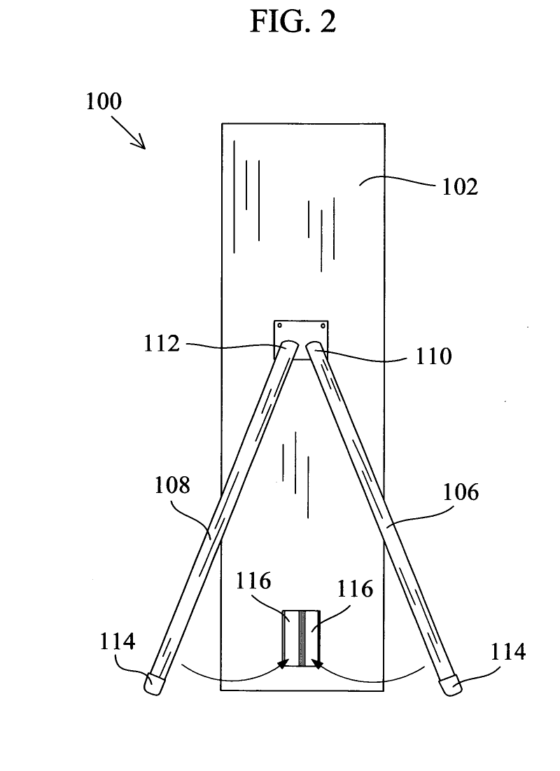

Turning now to FIG. 1 and FIG. 2:

FIG. 1 depicts a perspective view of one embodiment of a hard box type pool cue case having the tripod stand and pool cue rest features in accordance with the inventive disclosures herein. FIG. 2 depicts a rear view of the hard box type pool cue case of FIG. 1 depicting the folding tripod stand and retaining clips in accordance with the inventive disclosures herein.

An elongated hard box pool cue case 100 is equipped with features of the inventive disclosures herein. The case comprises a case base member 102 and a case lid member 104 hingeably attached to the base member 102. A tripod stand having two folding legs 106 and 108 is provided for supporting the case 100 in an inclined upright position. The legs 106 and 108 of the tripod stand are pivotally secured at an upper end 110, 112 to the base member 102 of the case 100. The legs of the tripod stand have an opposing second end having slip resistant feet 114 adapted to support the case in an angled upright position upon the floor. A means of holding the tripod stand 108, 110 in a folded position against the case base member 102 is provided by clips 116 secured to the base member 102 of the pool cue case 100. A pool cue rest is provided on the lid member 104 of the case 100. The pool cue rest comprises a bottom cue support member 118 which is hingeably secured to a front wall 120 of the lid member 104 of the case 100. The bottom cue support member 118 is closable into the recess 122 in the front wall 120 so as to provide a flush smooth appearance when closed. For use as a pool cue rest the bottom cue support member 118 is foldable outwards substantially perpendicular to the front wall 120 for supporting a butt end of a pool cue upon the bottom cue support member 118.

A top cue support member 124 is hingeably secured to the front wall 120 of the lid member 104 of the case 100. The top cue support member 124 is foldable into the recess 126 in the front wall 120 so as to provide a flush appearance. The top cue support member 124 is foldable outwards to a position substantially perpendicular to the front wall 120 for supporting a tip end of a pool cue while the butt end of cue rests upon the bottom cue support member 118.

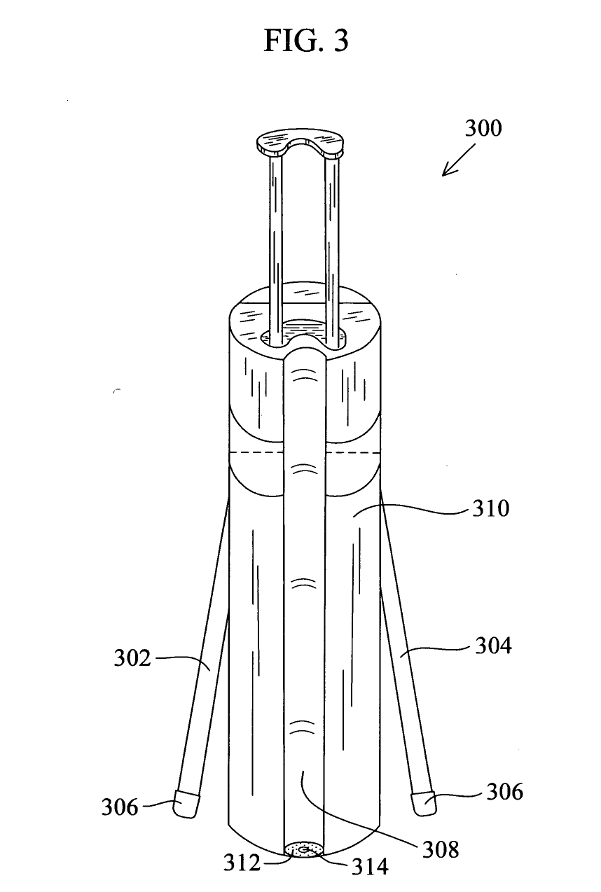

Turning now to FIG. 3:

FIG. 3 depicts a perspective view of another embodiment of a pool cue case 300 having the tripod stand and pool cue rest features in accordance with the inventive disclosures herein. Pool cue case 300 has a tripod stand having two folding legs 302, 304 provided for supporting the case 300 in an inclined upright position upon a floor. The legs of the tripod stand have slip resistant feet 306 adapted to support the case in an upright position on the floor. An elongated recessed channel 308 is formed into the front wall 310 of the case 300 for supportively resting a pool cue within. The recessed channel 308 is aligned along a major length of the case such that when the case is positioned in an angled upright position upon its tripod legs 302, 304 the channel 308 is aligned in an inclined upright position. The wall of the channel 308 is formed of a light transmitting material such as a transparent or translucent plastic or glass (for example). A bottom support member 312 is formed at a bottom end of the channel 308, the bottom support member 312 is sized for supporting the butt end of a pool cue thereon. A pressure sensitive switch 314 is secured to the bottom support member 312. The pressure sensitive switch 314 is equipped with contacts that close when a pool cue is placed upon the bottom support member 312, the contacts later reopening when the cue is removed. One or more electrically operated lights are secured behind the light transmitting wall of the channel 308 to illuminate the recessed channel 308. The lights electrically connected to battery (not shown) within the case 300 and the contacts of the pressure sensitive switch 314, wherein placing a pool cue on the bottom support member 312 energizes the lights and illuminates the recessed channel 308.

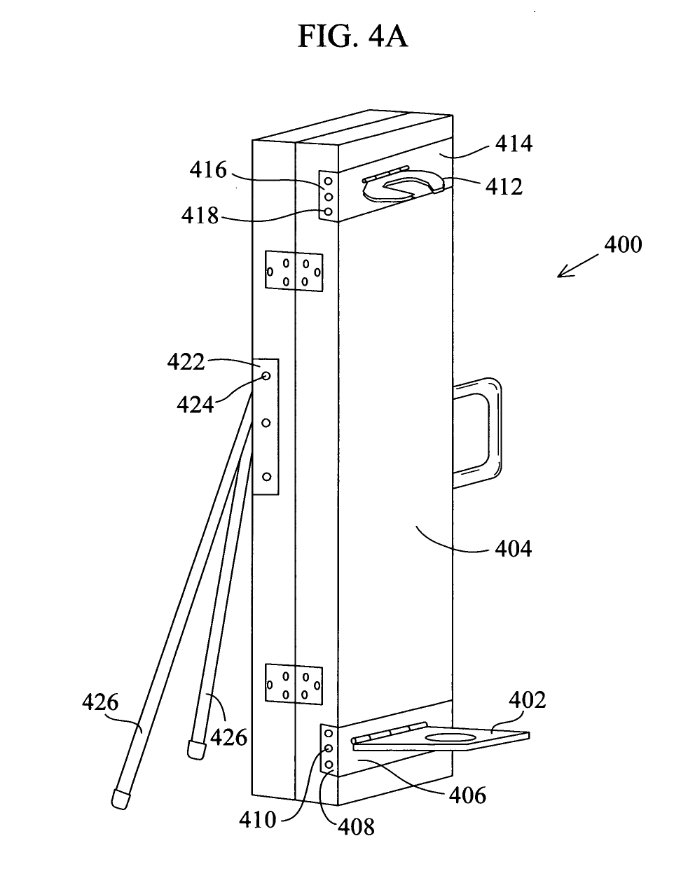

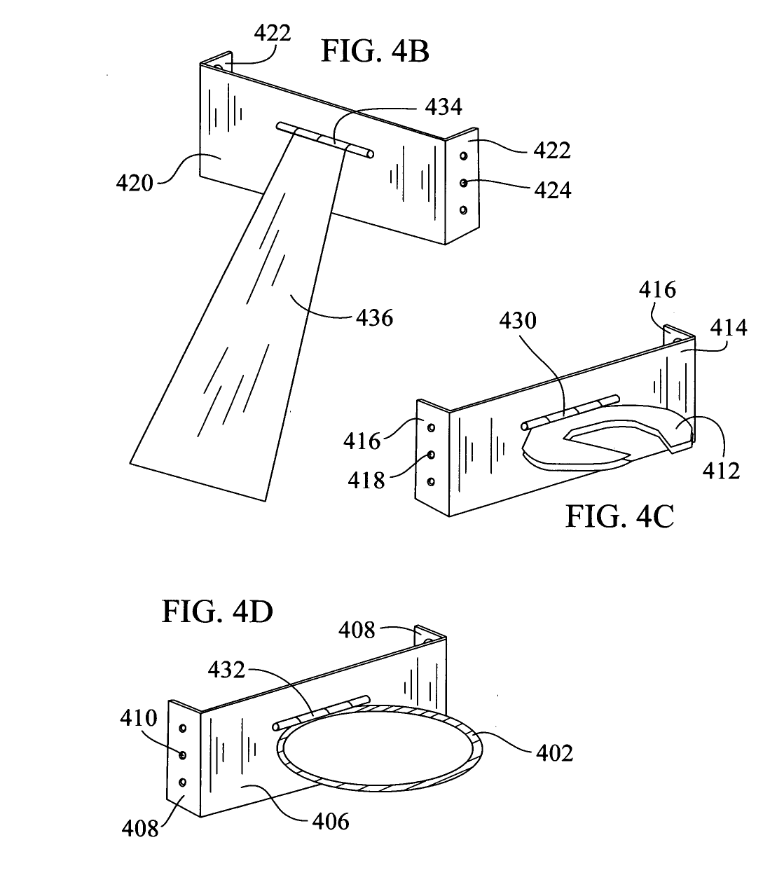

Turning now to FIGS. 4A, 4B, 4C and 4D:

FIG. 4A depicts a perspective view of one embodiment of a kit having various components installed onto and adapting a pool cue case 400 to have a tripod stand and pool cue rest in accordance with the inventive disclosures herein. FIG. 4B depicts a perspective view of another embodiment of a tripod stand for the kit depicted in FIG. 4A in accordance with the inventive disclosures herein. FIG. 4C depicts an enlarged perspective view of the top cue support member of FIG. 4A. FIG. 4D depicts an enlarged perspective view of the bottom cue support member of FIG. 4A. The pool cue rest comprises a foldable bottom cue support member 402. The bottom cue support member 402 being foldable outwards to a position substantially perpendicular to a front wall 404 of the pool cue case 400 for supporting the butt end of a pool cue upon the bottom cue support member 402. The bottom cue support member 402 is hingeably attached to the back member 406 of the “U” shaped bracket. The sides 408 have a plurality of holes 410 sized to receive screws for securing the sides 408 of the bracket to the case 400. Top cue support member 412 is hingeably attached to the back member 414 of the ‘U’ shaped bracket by the hinge 430. The ‘U’ shaped bracket having a flat back member 414 and two opposing sides 416 formed perpendicular to the back member 414 of the bracket. The sides 416 having a plurality of holes 418 sized to receive screws for securing the ‘U’ shaped bracket to the case, wherein the top cue support member 412 is foldably attached to the back member 414 of the second ‘U’ shaped bracket. A third ‘U’ shaped bracket has a flat back member 420 and two opposing sides 422 formed perpendicular to the back member 420 of the third bracket. The sides 422 having a plurality of holes 424 sized to receive screws for securing the bracket to the case, wherein the legs of the tripod stand 426 are foldably attached to the back member 420 of the third bracket. FIG. 4B depicts another embodiment of the tripod stand wherein the legs are replaced with a flat trapezoidal member 436 which is foldably attached to the back member 420 by the hinge 434.

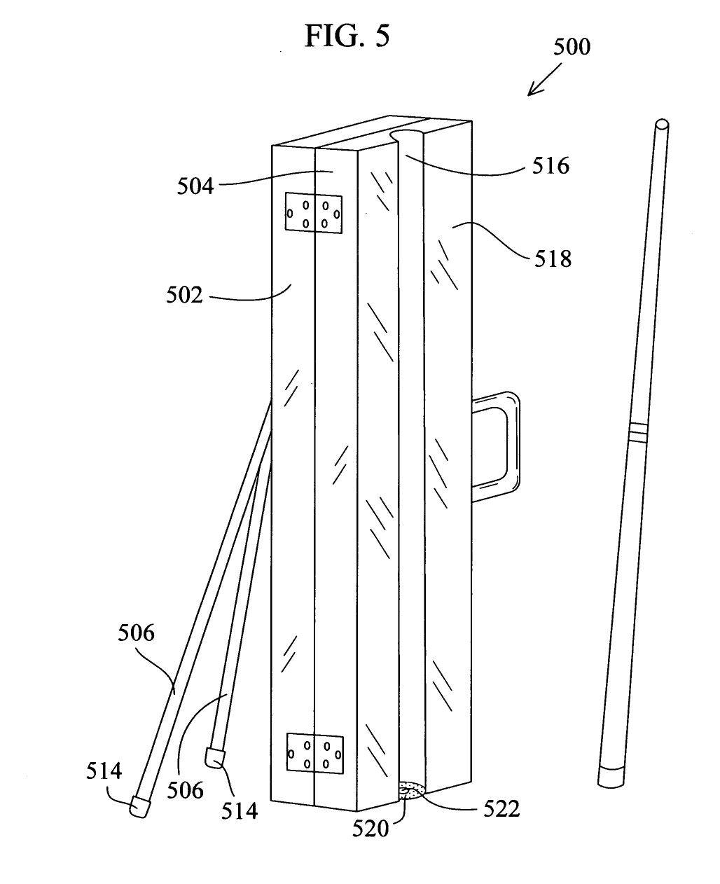

Turning now to FIG. 5:

FIG. 5 depicts a perspective view of another embodiment of a hard box type pool cue case having the tripod stand and pool cue rest features in accordance with the inventive disclosures herein.

An elongated hard box pool cue case 500 is equipped with features of the inventive disclosures herein. The case comprises a case base member 502 and a case lid member 504 hingeably attached to the base member 502. A tripod stand having two folding legs 506 is provided for supporting the case 500 in a inclined upright position. The legs 506 of the tripod stand are pivotally secured at an upper end to the base member 502 of the case 500. The legs of the tripod stand have an opposing second end having slip resistant feet 514 adapted to support the case in an upright position on the floor. An elongated recessed channel 516 is formed into the front wall 518 of the case for supportively resting a pool cue within. The channel 516 is aligned along a major length of the case 500 such that when the case 500 is upright on its tripod legs 506 the channel 516 is aligned in an inclined upright position. The channel 516 is formed of a light transmitting material such as transparent or translucent plastic or glass, for example. A bottom support member formed the bottom end of the channel 516, the bottom support member 520 is sized and adapted for supporting the butt end of the pool cue. A pressure sensitive switch 522 is secured to the bottom support member 520. The pressure sensitive switch 522 closing when a pool cue 530 is placed in the bottom support member 520 and opening when the cue is removed. One or more electrically operated lights are secured behind the light transmitting wall of the channel 516 to illuminate the recessed channel 516. The lights electrically connected to a battery (not shown) within the case 500 and the contacts of the pressure sensitive switch 522, wherein placing a pool cue on the bottom support member 520 energizes the lights and illuminates the recessed channel 516.

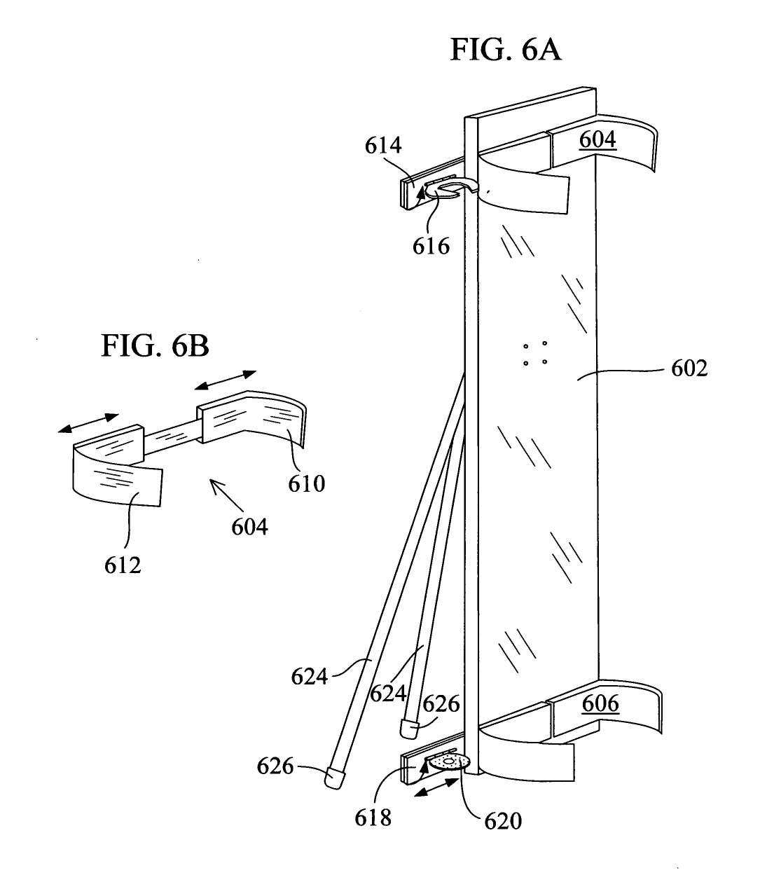

Turning now to FIGS. 6A and 6B:

FIGS. 6A and 6B depict a perspective view of another embodiment of a kit for adapting a tube case pool cue case to have the tripod stand and pool cue rest in accordance with the inventive disclosures herein. The kit further includes a frame member 602 sized and adapted to extend along a portion of length of the tube type pool cue case. The kit further includes two adjustable compression clamps 604, 606 with each clamp having two opposing ‘C’ shaped clamp arms 610, 612, wherein the arms are sized and adapted to engage opposing sides of the tube case (not shown), each clamp is secured to opposing ends of the frame member 602, wherein the frame member is adapted to be removably secured to the tube case. The top ‘C’ shaped clamp 604 is equipped with a sliding member 614 having the top cue support member 616 hingeably attached thereon. The bottom ‘C’ shaped clamp 606 is equipped with a sliding member 618 having the bottom support member 620 hingeably secured thereon. To store the support members when not in use, the support members 620, 616 are folded back against the sliding members 618, 614 and the sliding members 618, 614 are retracted into the flame 602 behind the ‘C’ shaped clamps 604, 606. The ‘C’ shaped clamps 604, 606 are compression clamps having an adjustable spacing between the left and right half clamps 610, 612. The left and right clamps adjust to fit a variety of tube type pool cases. A tripod stand 624 is foldably secured to a back surface of the flame member 602. The tripod legs 624 have slip resistant feet 626 adapted to support the case in an upright position on the floor.

The discussed construction, illustrations and sequence of operation is for one embodiment of the invention, but is in no way limiting to other embodiments. The operating modes may be changed and enhanced without deviating from the intention of this inventive disclosure.

In the preceding detailed description, reference has been made to the accompanying drawings that form a part hereof, and in which are shown by way of illustration specific embodiments in which the invention may be practiced. These embodiments and certain variants thereof have been described in sufficient detail to enable those skilled in the art to practice the invention. It is to be understood that other suitable embodiments may be utilized and that logical, material, and mechanical changes may be made without departing from the spirit or scope of the invention. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A pool cue case comprising:
an elongated hard box pool cue case having a case base member and a case lid member hingeably attached to the base member, the case having a recess within for protectively receiving and storing a pool cue;
a tripod stand for supporting the case in an inclined upright position, the tripod stand having one end foldably secured to the base member of the case by a hinge member, the tripod stand having an opposing second end adapted to support the case in an inclined upright position upon a floor surface by resting upon the tripod stand and one sidewall of the case, the second end having slip resistant feet secured thereto, the tripod stand foldable against a back wall of the case base member when not used to support the cue case in an upright position, the tripod stand foldable outwards from the case to support the case in the upright position;
a means of holding the tripod stand in a folded position against the base member of the case when not in use;
a pool cue rest comprising a means of supporting a pool cue in an inclined upright alignment proximate to a front wall of the case wherein the butt end of the pool cue is supported by the front wall of the case; and
one or more clasps for holding the case base member and lid members in a closed position,
wherein the pool cue is held in an inclined vertical position with the tip end if the cue extending upwards from the floor at an elevation that places the pool cue in easy reach of pool player without requiring the player to stoop over to retrieve the pool cue, wherein the pool cue is sheltered against and supported by the pool cue case, wherein the pool cue case is maintained in an inclined vertical position by the tripod floor stand.

2. The pool cue case of claim 1 wherein:
the mean of supporting the pool cue comprises:
a bottom cue support member hingeably secured to a front wall of the lid member of the case, the bottom cue support member foldable into the front wall flush with the front wall when not in use, the bottom cue support member foldable outwards substantially perpendicular to the front wall for supporting a butt end of a pool cue upon the bottom cue support member; and
a top cue support member hingeably secured to a front wall of the lid member of the case, the top cue support member foldable into the front wall flush with the front wall when not in use, the top cue support member foldable outwards substantially perpendicular to the front wall for supporting a tip end of a pool cue while butt end of cue rests upon the bottom cue support member.

3. The pool cue case of claim 1 wherein:
the means of supporting the pool cue comprises:
an elongated recessed channel formed into the front wall of the case for supportively resting a pool cue within, the channel aligned with a major length of the case such that when the case is in the inclined upright position on its tripod legs the channel is aligned in inclined upright position, the channel having an upper end and a lower end, the channel formed of a light transmitting material; and
a bottom support member formed at the bottom end of the channel, the bottom support member for supporting butt end of the pool cue.

4. The pool cue case of claim 3, further comprising:
two elongated top support slide rods, the rods in spaced parallel relationship, the rods telescopically received into top portion of the cue case, the rods substantially aligned with and telescoping parallel to an axis of elongation of the recessed channel;
a top cue support member, the top cue support member bridging between and secured to an upper end of the two elongated top support slide rods, the top cue support member having a concave portion aligned with the axis of elongation of the recessed channel, wherein a pool cue placed into the recessed channel having the butt end resting upon the bottom support member has the tip end of the pool cue supported by the top cue support member, wherein the slide rods are retractable into the case when the top cue support member is not needed to support a pool cue.

5. A kit for adding a tripod stand and pool cue rest to a pool cue case, the kit comprising:
a pool cue rest comprising:
a foldable bottom cue support member, the bottom cue support member foldable outwards substantially perpendicular to a front wall of the pool cue case, the bottom cue support member for supporting a butt end of a pool cue upon the bottom cue support member;
a means of securing the bottom cue support member to the case;
a top cue support member, the top cue support member foldable outwards substantially perpendicular to the front wall of the pool case, the top cue support member for supporting a tip end of a pool cue while butt end of cue rests upon the bottom cue support member; and
a means of securing the bottom cue support member to the case;
a foldable tripod stand for supporting the case in an inclined upright position when resting upon a floor;
a means of securing the tripod stand to the case, wherein the tripod stand is foldable outwards from the case to support the case in the inclined upright position.

6. The kit of claim 5, wherein:
the pool cue case is a hard case;
the means of securing the bottom cue support member to the case comprises a first ‘U’ shaped bracket having a flat back member and two opposing sides formed perpendicular to the back member, the sides having a plurality of holes sized to receive screws for securing the bracket to the case, wherein the bottom cue support member is foldably attached to the back member of the first ‘U’ shaped bracket;
the means of securing the top cue support member to the case comprises a second ‘U’ shaped bracket having a flat back member and two opposing sides formed perpendicular to the back member of the second bracket, the sides having a plurality of holes sized to receive screws for securing the second ‘U’ shaped bracket to the case, wherein the top cue support member is foldably attached to the back member of the second ‘U’ shaped bracket; and
the means of securing the tripod stand to the case comprises a third bracket having a flat back member and two opposing sides formed perpendicular to the back member of the third bracket, the sides having a plurality of holes sized to receive screws for securing the bracket to the case, the third bracket forming a ‘U’ shaped bracket, wherein the tripod stand is foldably attached to the back member of the third bracket.

7. The kit of claim 5, wherein the pool cue case is a tube case, wherein:
the kit further includes a frame member sized and adapted to extend along a portion of length of the tube case;
the kit further includes two adjustable compression clamps, each clamp having two opposing ‘C’ shaped clamp arms, wherein the arms are sized and adapted to engage opposing sides of the tube case, each clamp secured to opposing ends of the flame member, wherein the frame member is adapted to be removably secured to the tube case;
the means of securing the top cue support member to the case comprises a first sliding member having the top cue support member foldably secured to the sliding member, the first sliding member slidably received into the top adjustable compression clamp;
the means of securing the bottom cue support member to the case comprises a second sliding member having the bottom cue support member foldably secured to the second sliding member, the second sliding member slidably received into the bottom adjustable compression clamp; and
the means of securing the tripod stand to the case comprises the tripod stand foldably secured to a back surface of the frame member.

8. The kit of claim 5, wherein the foldable tripod stand comprises a flat trapezoidal member.

9. A case for a musical instrument comprising:
an elongated instrument case having a case base member and a case lid member hingeably attached to the base member, the case having a recess within for protectively receiving and storing a musical instrument;
a tripod stand for supporting the case in a standing inclined upright position, the tripod stand having one end foldably secured to the base member of the case by a hinge member, the tripod stand having an opposing second end adapted to support the case in a substantially upright position upon a floor surface by resting upon tripod stand and one sidewall of the case, the second end having slip resistant feet secured thereto, the tripod stand foldable against a back wall of the case base member when not used to support the musical instrument case in an upright position, the tripod stand foldable outwards from the case to support the case in the upright position;
a means of holding the tripod stand in a folded position against the base member of the case when not in use;
an instrument rest comprising a means of supporting an instrument in a substantially vertical alignment proximate to a front wall of the case wherein the musical instrument is supported by the front wall of the case; and
one or more clasps for holding the case base member and lid members in a closed position.

10. The case for a musical instrument of claim 6, wherein:
the musical instrument is selected from the set consisting of violin, flute, horn, guitar.

11. The pool cue case of claim 3 further comprising:
a pressure sensitive switch secured to the bottom support member, the pressure sensitive switch having electrical contacts adapted to close when a pool cue is placed in the bottom support member and open when the cue is removed;
one or more batteries removably secured within the case; and
one or more lights secured to the case and positioned behind the recessed channel to illuminate the recessed channel, the lights electrically connected to the batteries and the pressure sensitive switch, wherein placing a pool cue on the bottom support member energizes the lights.
